(19) United States
(12) Patent Application Publication
(10) Pub. No.: US 2014/0375622 A1
(43) Pub. Date: Dec. 25, 2014

(54) DISPLAY DEVICE AND DISPLAY METHOD

(71) Applicants: Yousuke Nakagawa, Osaka-shi (JP); Kazuhiro Maeda, Osaka-shi (JP)

(72) Inventors: Yousuke Nakagawa, Osaka-shi (JP); Kazuhiro Maeda, Osaka-shi (JP)

(73) Assignee: SHARP KABUSHIKI KAISHA, Osaka-shi, Osaka (JP)

(21) Appl. No.: 14/375,832

(22) PCT Filed: Jul. 9, 2012
(86) PCT No.: PCT/JP2012/067477

§ 371 Date: Jul. 31, 2014

(30) Foreign Application Priority Data
Feb. 10, 2012 (JP) 2012-27071

(51) Int. Cl. G09G 3/36

(52) U.S. Cl. CPC G09G 3/3674
USPC 345/212

(57) ABSTRACT

A scanning order calculating portion (23) included in a display control circuit (200) determines the order of selecting all rows by repeating the following: the row for which the total amount of potential variation relative to a reference row is the lowest is selected as a subsequent row, and the row having been selected as the subsequent row is used as the next reference row in a similar operation to determine the next row to be set as a subsequent row. A scanning order setting portion (24) controls an address outputting portion (26) such that the scanning signal lines are selected in the determined order, and also controls digital image signals DV outputted by output frame memory (22). Power consumed by driving video signal lines can be reduced by selecting the scanning signal lines in such an order that the total amount of potential variation of the video signal lines becomes smaller.

### TECHNICAL FIELD

The present invention relates to display devices, more specifically to an active-matrix display device and a display method in which the order of scanning is changed.

### BACKGROUND ART

In general liquid crystal display devices, polarity inversion drive is performed in order to suppress liquid crystal deterioration. A known polarity inversion drive scheme is a scheme (frame inversion drive scheme) in which the polarity of a voltage applied to the liquid crystal is inverted every frame. However, this drive scheme is subject to display defects, such as flicker, upon display, and therefore, in the drive schemes employed in recent years, the polarity of an applied voltage is inverted every horizontal scanning line and also every frame (a so-called “line inversion drive scheme”) or the polarity of an applied voltage is inverted every two vertically/horizontally adjacent pixels and also every frame (a so-called “dot inversion drive scheme”).

The dot inversion drive scheme is less prone to the occurrence of flicker, so that high-quality display can be achieved, but the polarity of a video signal to be applied to the liquid crystal panel is switched between predetermined voltages respectively above and below the potential of the common electrode, and therefore, the voltage swing of a video signal outputted by a liquid crystal panel driver is large, so that power consumption tends to be high. Moreover, in the line inversion drive also, more power consumption can be saved as the polarity inversion cycle of a video signal becomes longer (i.e., as the number of inversions per frame decreases).

Accordingly, only the odd scanning lines are sequentially selected in order to output signals from a source driver, and thereafter, polarity inversion is performed, so that only the even scanning lines are sequentially selected in order to output signals from the source driver, whereby line inversion drive or dot inversion drive can be realized by simply performing one polarity inverting operation per frame. Such a drive scheme is called an interlaced scanning scheme or an interlacing drive scheme.

However, even when such a drive scheme is employed, the potentials of video signals might change significantly depending on the image to be displayed, which results in a large voltage swing, so that power consumption tends to become high.

Therefore, Japanese Laid-Open Patent Publication No. 7-64512 discloses the configuration of a liquid crystal drive device in which binary digital video signals are used, and the order of selecting the scanning signal lines is determined such that the number of times the liquid crystal is charged/discharged is minimized. With this configuration, power consumed by charging/discharging the liquid crystal is minimized, resulting in reduced power consumption by the entire device.

### CITATION LIST

### Patent Document

Patent Document 1: Japanese Laid-Open Patent Publication No. 7-64512

### SUMMARY OF THE INVENTION

### Problems to be Solved by the Invention

However, even when the configuration described in Japanese Laid-Open Patent Publication No. 7-64512 is applied to a general liquid crystal display device using analog data (video signals at multiple grayscale levels), the power consumed by charge/discharge is not always minimized. Even if the number of charges/discharges is minimized, the potentials of video signals might change significantly depending on the image to be displayed, and in such a case, power consumption is increased.

Therefore, an objective of the present invention is to provide a display device and a display method in which analog data is used, and the total amount of potential variation of video signal lines can be reduced.

### Solution to the Problems

A first aspect of the present invention is directed to a display device for displaying an image by a plurality of pixel forming portions arranged along a plurality of video signal lines for transmitting a plurality of video signals and a plurality of scanning signal lines crossing the video signal lines, the device comprising:

a video signal line drive circuit for driving the video signal lines on the basis of an image signal representing the image;

a scanning signal line drive circuit for selectively driving the scanning signal lines; and

a scanning order determination circuit for determining order of selecting the scanning signal lines on the basis of the image signal so that the video signal lines are driven with lower power than power required for driving the video signal lines when the scanning signal lines are selected in order of arrangement.

In a second aspect of the present invention, based on the first aspect of the invention, the scanning order determination circuit determines at least a part of the order so as to minimize an integral of absolute values of amounts of potential variation caused for each of at least a part of the video signal lines upon each change of a scanning signal line selected by the scanning signal line drive circuit.

In a third aspect of the present invention, based on the second aspect of the invention, the scanning order determination circuit determines a scanning signal line to be selected next so as to minimize the integral of the absolute values of the amounts of potential variation, and the scanning order determination circuit also determines another scanning signal line to be selected following the selection of the preceding scanning signal line so as to minimize the integral of the absolute values of the amounts of potential variation.

In a fourth aspect of the present invention, based on the third aspect of the invention, the scanning order determination circuit determines a scanning signal line that is to be selected first from among the scanning signal lines to display the image, so as to minimize the integral of the absolute values of the amounts of potential variation, the first scanning signal line being selected next after the last scanning signal line selected so as to display an immediately preceding image.

In a fifth aspect of the present invention, based on the third aspect of the invention, the scanning order determination circuit determines a scanning signal line that is to be selected first from among the scanning signal lines, so as to minimize an integral of absolute values of potential differences of the video signal lines from a predetermined potential.

In a sixth aspect of the present invention, based on the third aspect of the invention, the scanning order determination circuit determines a scanning signal line that is to be selected to display the first row of the image, as the first to be selected from among the scanning signal lines.

In a seventh aspect of the present invention, based on the second aspect of the invention, the scanning order determination circuit calculates the integral on the basis of a predetermined number of upper bits of digital grayscale data included in the image signal and representing potentials to be applied to the video signal lines.

In an eighth aspect of the present invention, based on the first aspect of the invention, after determining the order, the scanning order determination circuit maintains the order until a predetermined wait period passes or until a predetermined start point.

In a ninth aspect of the present invention, based on the eighth aspect of the invention, the scanning order determination circuit sets the start point to be a point of detection of a change in the image or sets the wait period longer when the image is determined to be a still image than when the image is determined to be a video image.

In a tenth aspect of the present invention, based on the first aspect of the invention, the scanning order determination circuit divides the video signal lines into groups of a predetermined number of adjacent scanning signal lines, and determines the order for each group.

In an eleventh aspect of the present invention, based on the tenth aspect of the invention, further comprised is memory with a capacity for storing digital grayscale data specifying potentials to be provided to the video signal lines in one of the groups.

In a twelfth aspect of the present invention, based on the first aspect of the invention, the scanning order determination circuit adds up absolute values of amounts of potential variation for each video signal line selected every predetermined integer multiple of 2 or more from among the video signal lines.

In a thirteenth aspect of the present invention, based on the first aspect of the invention, the scanning signal line drive circuit is an address decoder, and the scanning order determination circuit provides the scanning signal line drive circuit with addresses in accordance with the order.

In a fourteenth aspect of the present invention, based on the first aspect of the invention, the scanning signal line drive circuit is disposed on each end side of the scanning signal lines such that the scanning signal lines are provided with signals at least from one end.

A fifteenth aspect of the present invention is directed to a method for displaying an image by a plurality of pixel forming portions arranged along a plurality of video signal lines for transmitting a plurality of video signals and a plurality of scanning signal lines crossing the video signal lines, the method comprising:

a video signal line drive step for driving the video signal lines on the basis of an image signal representing the image;

a scanning signal line drive step for selectively driving the scanning signal lines; and

a scanning order determination step for determining the order of selecting the scanning signal lines on the basis of the image signal so that the video signal lines are driven with lower power than power required for driving the video signal lines when the scanning signal lines are selected in order of arrangement.

### Effect of the Invention

In the first aspect of the present invention, the order of selecting the scanning signal lines is determined such that the video signal lines are driven with lower power than when the scanning signal lines are selected in order of arrangement so that power consumed by driving the video signal lines can be reduced.

In the second aspect of the present invention, at least a part of the order is determined so as to minimize the integral of absolute values of amounts of potential variation caused for each of at least apart of the video signal lines upon each scanning signal line change so that power consumed by driving the video signal lines can be reduced.

In the third aspect of the present invention, the next scanning signal line to be selected so as to minimize the integral of the absolute values of the amounts of potential variation is determined, and the subsequent scanning signal line to be selected following the selection of the preceding scanning signal line so as to minimize the integral of the absolute values of the amounts of potential variation is determined so that power consumed by driving the video signal lines can be reduced.

In the fourth aspect of the present invention, the first to be selected from among the scanning signal lines to display an image is the scanning signal line that is to be selected so as to minimize the integral of the absolute values of the amounts of potential variation, and the first scanning signal line is selected next after the last scanning signal line selected so as to display an immediately preceding image, so that in the configuration where the potentials applied to video signal lines the last time the video signal lines are selected remain unchanged, the integral of the amounts of potential variation of the video signal lines can be minimized even upon switching of images. Thus, power consumed by driving the video signal lines can be reduced significantly.

In the fifth aspect of the present invention, the first to be selected from among the scanning signal lines is the scanning signal line that is to be selected so as to minimize the integral of absolute values potential differences of the video signal lines from a predetermined potential, and therefore, for example, in the case where specific potentials are applied to the video signal lines at the startup, power-on, or standby of the device, or during a vertical blanking period, power consumed by driving the video signal lines can be reduced.

In the sixth aspect of the present invention, the first to be selected from among the scanning signal lines is the scanning signal line that is to be selected to display the first row of the image, and therefore, for example, in the case where the potentials of the video signal lines are not constant during a vertical blanking period, power consumed by driving the video signal lines can be reduced using a simplified configuration.

In the seventh aspect of the present invention, the integral is calculated on the basis of a predetermined number of upper bits of the digital grayscale data, so that computation can be simplified, the speed of the entire computation can be enhanced, and further, power consumed by computation can be reduced.

In the eighth aspect of the present invention, after the order is determined, the determined order is maintained until a predetermined waiting time passes or until a predetermined start point, resulting in less computation and reduced power consumption for computation.

In the ninth aspect of the present invention, the start point is a point of detection of a change in the image, or the wait period is set longer when the image is determined to be a still image than when the image is determined to be a video image, so that computation is reduced appropriately in accordance with, for example, a change in the image, resulting in reduced power consumption for computation.

In the tenth aspect of the present invention, the scanning signal lines are divided into groups of a predetermined number of adjacent scanning signal lines, and the order is determined for each group, so that a hold duration of at least half a frame can be ensured so that satisfactory display quality can be maintained.

In the eleventh aspect of the present invention, the provided memory has a capacity for storing digital grayscale data specifying potentials to be provided to the video signal lines in one group, so that the need for large-sized memory as typified by frame memory can be eliminated, resulting in reduced production cost.

In the twelfth aspect of the present invention, the integral of absolute values of the amounts of potential variation is calculated for each video signal line selected every predetermined integer multiple of 2 or more, so that the amount of computation to obtain the integral can be decreased, resulting in reduced power consumption for computation.

In the thirteenth aspect of the present invention, a general address decoder is used as the scanning signal line drive circuit, so that the device can be produced in a simplified configuration, and the order of selecting scanning signal lines can be changed freely in a simplified manner.

In the fourteenth aspect of the present invention, the scanning signal line drive circuit is positioned on each end side of the scanning signal lines, and therefore, the scale (size) of the circuit (on each side) can be reduced. Further, in the case where scanning signals are provided from both ends, the scanning signals are not distorted, so that the scanning lines can be selected both quickly and reliably.

The fifteenth aspect of the present invention allows a display method to achieve the same effects as those achieved by the first aspect of the present invention.

### BRIEF DESCRIPTION OF THE DRAWINGS

FIG. 1 is a block diagram illustrating the overall configuration of an active-matrix liquid crystal display device according to a first embodiment of the present invention.

FIG. 2 is a circuit diagram illustrating an equivalent circuit of a pixel forming portion in the embodiment.

FIG. 3 is a block diagram illustrating the configuration of a display control circuit in the embodiment.

FIG. 4 is a flowchart illustrating the flow of processing by a scanning order calculating portion to calculate the order of selecting rows in the embodiment.

FIG. 5 is a table listing the order of selecting four scanning signal lines and the values of voltages to be applied to a video signal line in an exemplary simplified configuration in a first configuration example of the embodiment.

FIG. 6 provides waveform charts of signals in the exemplary simplified configuration in the embodiment.

FIG. 7 is a table listing the order of selecting four scanning signal lines and the values of voltages to be applied to a video signal line in an exemplary simplified configuration in a third configuration example of the embodiment.

FIG. 8 is a partial block diagram illustrating a display data signal being inputted to input frame memory and then to a scanning order calculating portion in the embodiment.

FIG. 9 is a table listing the order of selecting four scanning signal lines and the values of voltages to be applied to a video signal line, along with corresponding input data and determination data, in another exemplary simplified configuration in the embodiment.

FIG. 10 is a block diagram illustrating the configuration of a display control circuit in a second embodiment of the present invention.

FIG. 11 is a block diagram illustrating the configuration of a display control circuit in a variant of the second embodiment of the present invention.

FIG. 12 is a block diagram illustrating the configuration of a display control circuit in another variant of the second embodiment of the present invention.

FIG. 13 is a block diagram illustrating the configuration of a display control circuit in a third embodiment of the present invention.

FIG. 14 is a table listing the order of selecting scanning signal lines for two consecutive frames in a simplified display device as in the first embodiment.

FIG. 15 provides waveform charts showing potential changes of scanning signal lines selected in the order of selection shown in FIG. 14.

FIG. 16 is a diagram illustrating an example where a display screen is divided into six blocks in the present embodiment.

FIG. 17 is a diagram partially illustrating potential changes of scanning signal lines in the six blocks in the present embodiment.

FIG. 18 is a table listing the order of selecting six scanning signal lines and the values of voltages to be applied to a video signal line in an exemplary simplified configuration in the embodiment.

FIG. 19 provides waveform charts of signals in an exemplary simplified configuration in the embodiment.

FIG. 20 is a circuit diagram illustrating an equivalent circuit of a pixel forming portion including an organic EL element.

### MODES FOR CARRYING OUT THE INVENTION

Hereinafter, embodiments of the present invention will be described with reference to the accompanying drawings.

### 1. First Embodiment

### 1.1 Overall Configuration and Operation of the Liquid Crystal Display Device

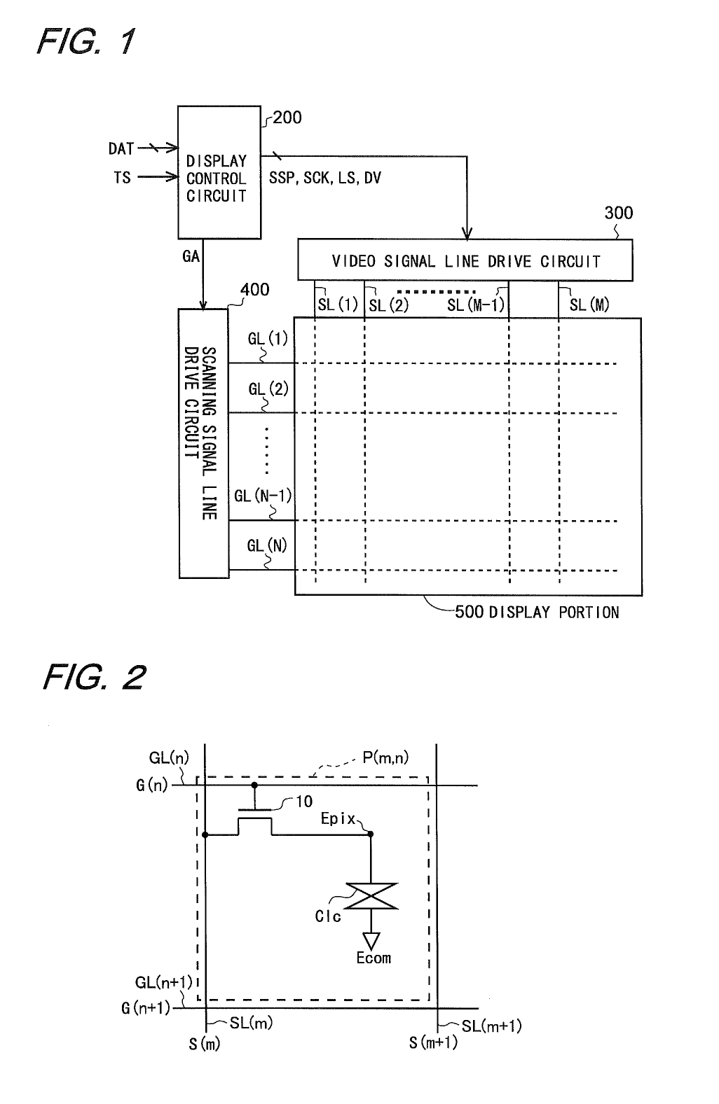

FIG. 1 is a block diagram illustrating the overall configuration of an active-matrix liquid crystal display device according to a first embodiment of the present invention. This liquid crystal display device includes a drive control portion consisting of a display control circuit 200, a video signal line drive circuit (source driver) 300, and a scanning signal line drive circuit (gate driver) 400, as well as a display portion 500. The display portion 500 includes a plurality (M) of video signal lines SL(1) to SL(M), a plurality (N) of scanning signal lines GL(1) to GL(N), and a plurality (M×N) of pixel forming portions provided along the video signal lines SL(1) to SL(M) and the scanning signal lines GL(1) to GL(N). Note that in the following, a pixel forming portion provided in association with and in the vicinity (in the figure, to the lower right) of the intersection of a scanning signal line GL(n) and a video signal line SL(m) will be denoted by the reference character “P(m, n)”. FIG. 2 illustrates an equivalent circuit of a pixel forming portion P(m, n) in the display portion 500 in the present embodiment.

As shown in FIG. 2, each pixel forming portion P(m, n) includes a TFT 10, which is a switching element having a gate terminal connected to a scanning signal line GL(n) and a source terminal connected to a video signal line SL(m) passing through the intersection or its adjacent video signal line SL(m+1), and the pixel forming portion P(m, n) also includes a pixel electrode Epix connected to a drain terminal of the TFT 10, a common electrode Ecom commonly provided for the pixel forming portions P(i, j) (where i=1 to M, and j=1 to N), and a liquid crystal layer commonly provided for the pixel forming portions P(i, j) (where i=1 to M, and j=1 to N) between the pixel electrode Epix and the common electrode Ecom.

The pixel forming portion P(m, n) has liquid crystal capacitance (also referred to as “pixel capacitance”) Clc formed by the pixel electrode Epix and the common electrode Ecom positioned on the opposite side of the liquid crystal layer therefrom. The pixel electrode Epix is positioned between the two video signal lines SL(m) and SL(m+1), and one of the two video signal lines is connected to the pixel electrode Epix via the TFT 10.

Note that the semiconductor layer of the TFT 10 is made of amorphous silicon, which can be produced readily at low cost, but other well-known materials, such as In—Ga—Zn—O (IGZO) based oxides and continuous grain silicon, can also be used. In particular, using an In—Ga—Zn—O (IGZO) based oxide semiconductor as the semiconductor layer results in quick response and extremely low current leakage, so that a low-power consumption drive mode such as low-frequency drive (intermittent drive) can be realized. Therefore, a further reduction in power consumption can be achieved in addition to the effects of the present embodiment.

The display control circuit 200 receives a display data signal DAT and a timing control signal Ts, which are transmitted externally, and outputs digital image signals DV as well as a source start pulse signal SSP, a source clock signal SCK, a latch strobe signal LS, and a gate address signal GA for controlling the timing of displaying an image on the display portion 500, as shown in FIG. 1.

Here, the external display data signal DAT includes, for example, parallel data consisting of 18 bits in total, i.e., red, green, and blue display data, which are all 6-bit data, each being provided to a corresponding pixel forming portion. These data are provided to video signal lines for their respectively corresponding colors.

The video signal line drive circuit 300 receives the digital image signals DV, the source start pulse signal SSP, the source clock signal SCK, and the latch strobe signal LS outputted by the display control circuit 200, and applies drive video signals S(1) to S(M) to the video signal lines SL(1) to SL(M) in order to charge the pixel capacitance Clc (and auxiliary capacitance) of the pixel forming portions P(m, n) in the display portion 500. At this time, the video signal line drive circuit 300 sequentially holds the digital image signals DV indicating voltages to be applied to the video signal lines SL(1) to SL(M), with the timing of pulse generation of the source clock signal SCK. Thereafter, the digital image signals DV being held are converted into analog voltages with the timing of pulse generation of the latch strobe signal LS. The analog voltages are applied simultaneously to all of the video signal lines SL(1) to SL(M) as drive video signals. That is, the scheme employed for driving the video signal lines SL(1) to SL(M) in the present embodiment is a line-sequential drive scheme.

Note that for the sake of simplified explanation, the present embodiment employs a line inversion drive scheme, which is a drive scheme in which the polarity of the voltage applied to the pixel liquid crystal is inverted every frame, but the line inversion drive scheme may be a drive scheme in which the polarity of the voltage applied to the pixel liquid crystal is inverted every row of the display portion 500 and also every frame, or even the dot inversion drive scheme as mentioned earlier may be employed.

The scanning signal line drive circuit 400 applies a corresponding one of the active scanning signals G(1) to G(N) to one of the scanning signal lines GL(1) to GL(N) on the basis of the gate address signal GA outputted by the display control circuit 200. More specifically, the scanning signal line drive circuit 400 is an address decoder, which selects one of the scanning signal lines GL(1) to GL(N) in accordance with an address included in a received gate address signal GA, and applies an active scanning signal to the selected scanning signal line. In the following, such an operation will also be expressed as “selecting a row (which is a display row corresponding to the selected scanning signal line)”.

Note that in FIG. 1, the scanning signal line drive circuit 400 provides scanning signals to the scanning signal lines GL(1) to GL(N) from one end, but the display portion 500 may be provided on each of the right and left sides so that the signals can be provided from both ends. As a result, the scale (size) of the circuit (on each side) can be reduced. Moreover, in the case where the scanning signals are provided from both ends, the scanning signals can be provided swiftly to the scanning signal lines GL(1) to GL(N), without causing distortion in the scanning signals, so that the scanning lines can be selected both quickly and reliably.

As will be described later, the display control circuit 200 sequentially determines addresses such that the scanning signal lines GL(1) to GL(N) are selected one by one until all of the lines are selected ultimately, so as to minimize the total amount (integral) of potential variation of the video signal lines SL(1) to SL(M), and thereafter, the display control circuit 200 outputs a gate address signal GA.

Note that in the present embodiment, to perform the frame inversion drive, an unillustrated common electrode drive circuit is provided so that a common voltage Vcom, which is a voltage to be provided to the common electrode of the liquid crystal, is inverted every frame. Moreover, in the case where the line inversion drive is performed, to suppress voltage swing of the video signal lines, the potential of the common electrode is preferably changed in accordance with the polarity inversion drive. More specifically, in accordance with a polarity inversion signal from the display control circuit 200, the common electrode drive circuit generates a voltage which switches between two reference voltage levels every row and every frame, and supplies it to the common electrode of the display portion 500 as the common voltage Vcom. These features make it possible to realize the line inversion drive scheme.

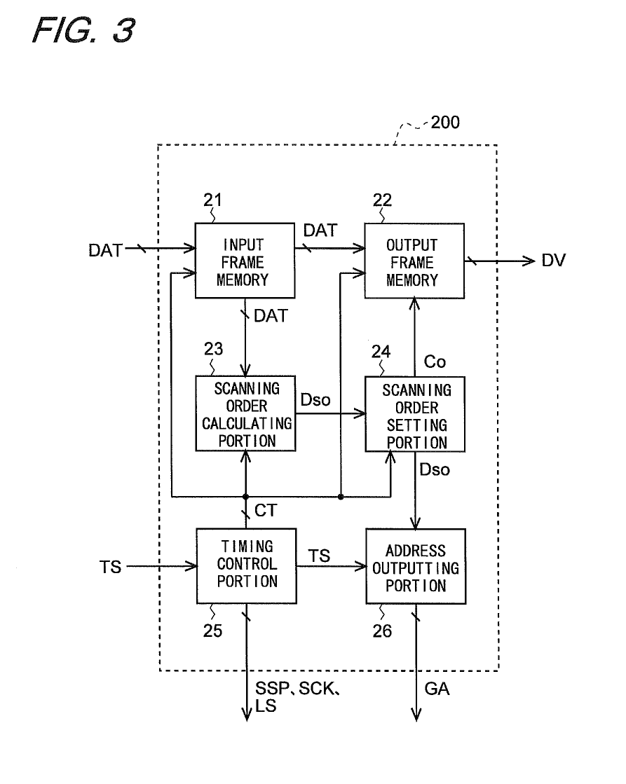

In this manner, drive video signals are applied to the video signal lines SL(1) to SL(M), and scanning signals are applied to the scanning signal lines GL(1) to GL(N) in an order to be described later, so that the display portion 500 displays an image. Next, the configuration and operation of the display control circuit 200 characterized by the manner in which the order of scanning the scanning signal lines is calculated will be described with reference to FIG. 3.

### 1.2 Configuration and Operation of the Display Control Circuit

FIG. 3 is a block diagram illustrating the configuration of the display control circuit 200 in the present embodiment. The display control circuit 200 includes input frame memory 21, output frame memory 22, a scanning order calculating portion 23, a scanning order setting portion 24, a timing control portion 25, and an address outputting portion 26.

The timing control portion 25 receives an externally transmitted timing control signal Ts, and outputs control signals CT for controlling the operations of the input frame memory 21, the output frame memory 22, the scanning order calculating portion 23, and the scanning order setting portion 24, as well as a source start pulse signal SSP, a source clock signal SCK, and a latch strobe signal LS for controlling the timing of displaying an image on the display portion 500. Further, the timing control portion 25 provides a timing control signal Ts to the address outputting portion 26 as well.

The input frame memory 22 stores an external display data signal DAT for one frame. Further, in accordance with a control signal CT from the timing control portion 25, the frame memory 22 outputs the stored display data signal DAT for one frame to the output frame memory 22 and the scanning order calculating portion 23 with appropriate timing. Thereafter, the input frame memory 22 stores another externally transmitted display data signal DAT for the next frame. As a result, the display data signal DAT stored in the output frame memory 22 is data that precedes the display data signal DAT stored in the input frame memory 21 by one frame. Note that the input frame memory 22 may be included in an unillustrated host controller which provides the display data signal DAT to the display control circuit 200.

On the basis of the external display data signal DAT, the scanning order calculating portion 23 calculates which row is to be selected next after a reference row is selected (i.e., after one horizontal scanning period) in order to minimize the total amount (integral) of potential variation of the video signal lines SL(1) to SL(M). Variations in potential of a video signal line means charge/discharge of the capacitance of the video signal line, including parasitic capacitance, and therefore, the larger the total amount of potential variation, the more power consumption.

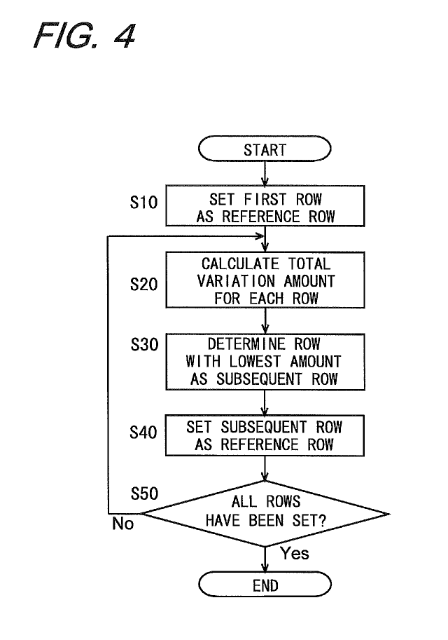

For example, power consumption is maximized when a selection operation is repeated such that the minimum potential corresponding to the minimum grayscale value is initially applied to a video signal line, and thereafter (one horizontal scanning period later), the maximum potential corresponding to the maximum grayscale value is applied to the video signal line. However, in this case, the total amount of potential variation of the video signal lines can be reduced by selecting the odd rows sequentially and thereafter selecting the even rows sequentially. In this manner, by changing the order of selection appropriately, the total amount of potential variation of the video signal lines can be reduced. Therefore, the scanning order calculating portion 23 calculates the appropriate order in accordance with the procedure shown in FIG. 4.

FIG. 4 is a flowchart illustrating the flow of processing by the scanning order calculating portion 23 to calculate the order of selecting rows. In step S10 shown in FIG. 4, the scanning order calculating portion 23 sets the first row as a reference row to be selected initially. The reference row is a row to be referenced in order to calculate the total amount (integral) of potential variation of the video signal lines due to the next row being selected, as will be described below. In this manner, the process of setting the first line as the line to be selected at the beginning of a frame is simple and suitable when the potentials of the video signal lines SL(1) to SL(M) are unstable during a vertical blanking period (i.e., when specific potentials are not provided). This configuration will be referred to as a first configuration.

However, at the time of power-on or standby of the device or during the vertical blanking period, specific potentials might be applied to the video signal lines SL(1) to SL(M). In such a case, if the first row is to be always selected at the beginning, as in the first configuration, the total amount of variation in the potential of a video signal line due to the first row being selected might be increased from such a specific potential. Therefore, in such a case, instead of performing the processing in step S10, the row for which the total amount (integral) of potential variation of the video signal lines SL(1) to SL(M) relative to the specific potential is minimum is preferably selected as the first reference row. This configuration will be referred to as a second configuration.

Furthermore, during the vertical blanking period, instead of applying the specific potential as described above, the potential applied in the row selected at the end of a frame might be maintained on the video signal lines SL(1) to SL(M). In this case also, if the first row is to be always selected at the beginning, as in the first configuration, the total amount of potential variation of the video signal lines due to the first row being selected might be increased. Accordingly, in such a case, instead of performing the processing in step S10, the row for which the total amount (integral) of potential variation of the video signal lines SL(1) to SL(M) relative to the potential applied in the row selected at the end of the frame is minimum is preferably selected as the first reference row. This configuration will be referred to as a third configuration.

In this manner, the first configuration corresponding to the processing in step S10 of the present embodiment might increase the amount of potential variation of the video signal lines depending on the operation mode of the device, and therefore, by employing the second or third configuration depending on the operation mode, power consumption can be further reduced.

Next, for each row, the scanning order calculating portion 23 calculates the total amount (integral) of potential variation of the video signal line due to the next row after the reference row being selected (step S20). Normally, if the total amount of potential variation is not calculated for each row, it is not possible to determine what number row from the reference row is to be selected in order to minimize the total amount of potential variation of the video signal lines SL(1) to SL(M). Therefore, the total amount of potential variation as represented by the following expression (1) is calculated for each row.

$${\sum }_{i = 1}^{M} {( Vai - Vji )}^{2} \qquad ( 1 )$$

However, in expression (1), “a” represents the reference row (whose initial value is 1), “i” represents the number (column number) for the video signal line, and “j” represents the number for the scanning signal line, i.e., the number for the row. Further, “Vji” represents the potential applied to the i'th video signal line (i'th column) when the j'th row (the j'th scanning signal line) is selected.

The scanning order calculating portion 23 sequentially calculates the total amount of variation represented by expression (1) for each row (more specifically, the calculation is performed by sequentially assigning the values in the range of from j=1 to j=N), and calculates the row for which the calculated total amount of potential variation of the video signal lines is the lowest among all of the rows, so that the obtained row is determined as the row that is to be selected next (referred to below as the “subsequent row”) (step S30).

Here, the amounts of potential variation of the video signal lines are computed on the basis of grayscale data corresponding to video signals to be applied to the video signal lines. More specifically, grayscale data corresponding to the columns (the video signal lines) in the reference row and the row for which the computations are to be performed are read from the input frame memory 21, and the total amount (integral) of potential variation is calculated in accordance with expression (1).

Note that if the speed of calculation allows, the total amount of potential variation is preferably obtained by adding up the amounts of potential variation actually having occurred for the video signal lines during each horizontal scanning period. For example, the scanning order calculating portion 23 has a (preset) table (referred to below as a “grayscale voltage table”) showing the correspondence between grayscale values (e.g., from 0 to 255) indicated by display data corresponding to drive video signals to be applied to a video signal line and voltage values for the drive video signal. In accordance with the grayscale voltage table, the scanning order calculating portion 23 calculates the amount of potential variation indicating a change of the potential of a video signal line corresponding to a provided drive video signal compared to the potential during the immediately preceding horizontal scanning period where the drive video signal corresponds to externally received display data.

Subsequently, the scanning order calculating portion 23 sets the subsequent row as a reference row (step S40), and determines whether or not all rows have already been set as the subsequent rows (step S50); if not all of the rows have yet been set (No in step S50), the process returns to step S20 and will be repeated until all of the rows are set (S50→S20→ . . . →S50), or if all of them have already been set (Yes in step S50), the process for one frame ends. Thereafter, a display data signal DAT for the next frame is provided to the input frame memory 21, and a similar operation to the above will be performed.

In this manner, all rows (for one frame) are selected by repeating the following: the row for which the total amount of potential variation relative to the initially set reference row is the lowest is selected as the subsequent row, and the row having been selected as the subsequent row is used as the next reference row in a similar operation to determine the next row to be set as the subsequent row. The scanning order calculating portion 23 generates scanning order data Dso specifying the order of selection, and provides the data to the scanning order setting portion 24.

The scanning order setting portion 24 provides the received scanning order data Dso to the address outputting portion 26 as well as an order control signal Co to the output frame memory 22 in order to control the output frame memory 22 such that digital image signals DV are outputted in order of data corresponding to the order specified by the scanning order data Dso.

The output frame memory 22 receives and stores a display data signal DAT for one frame from the input frame memory 21; the display data signal DAT includes grayscale data which is sequenced on the premise that the scanning signal lines are selected in order of sequence. The scanning order setting portion 24 controls the output frame memory 22 by changing (or rearranging) the order of sequence or by making no rearrangements, such that the data are outputted in order as mentioned above.

Furthermore, the address outputting portion 26 provides an address which specifies its corresponding scanning line to the scanning signal line drive circuit 400, which functions as an address decoder, as a gate address signal GA in accordance with the received scanning order data Dso. The scanning signal line drive circuit 400 selects one of the scanning signal lines GL(1) to GL(N) in accordance with the address included in the received gate address signal GA.

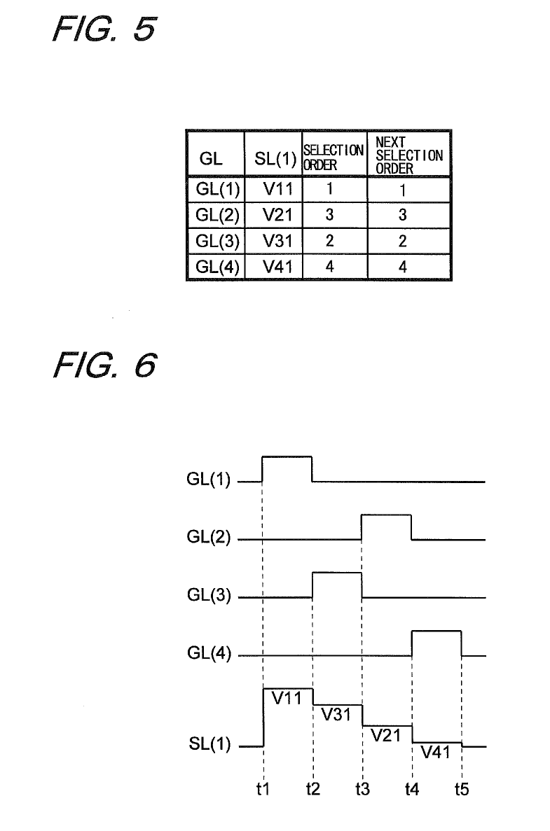

In this manner, the display control circuit 200 selects the scanning signal lines GL(1) to GL(N) in the aforementioned order, and supplies the video signal lines SL(1) to SL(M) with their corresponding drive video signals S(1) to S(M) to be provided when the rows are selected. As a result, the total amount of potential variation of the video signal lines can be minimized. This will be described using a simple and specific example with reference to FIGS. 5 and 6.

FIG. 5 is a table listing the order of selecting four scanning signal lines and the values of voltages to be applied to a video signal line in the first configuration example. For this simple example of a display device including the four scanning signal lines GL(1) to GL(4) and the video signal line SL(1), FIG. 5 lists drive video signal voltages Vj1 (V11 to V41) applied to the video signal line SL(1) when the scanning signal lines GL(j) (where j=1 to 4) are selected, along with the order of selecting the lines. Note that FIG. 5 also lists the order of selection for the next frame, which is the same as the order of selection for the preceding frame since the scanning signal line SL(1), which corresponds to the first row, is always selected first, as described earlier in conjunction with the first configuration.

FIG. 6 provides waveform charts of the signals in the simple example of the display device as above. The scanning signal lines GL(1) to GL(4) are selected in the order of selection shown in FIG. 5, so that the scanning signal line GL(1) is active from time t1 to time t2, the scanning signal line GL(3) is active from time t2 to time t3, the scanning signal line GL(2) is active from time t3 to time t4, and the scanning signal line GL(4) is active from time t4 to time t5, as shown in FIG. 6. Further, when their corresponding scanning signal lines are active, the corresponding drive video signal voltages V11 to V41 are applied to the video signal line SL(1).

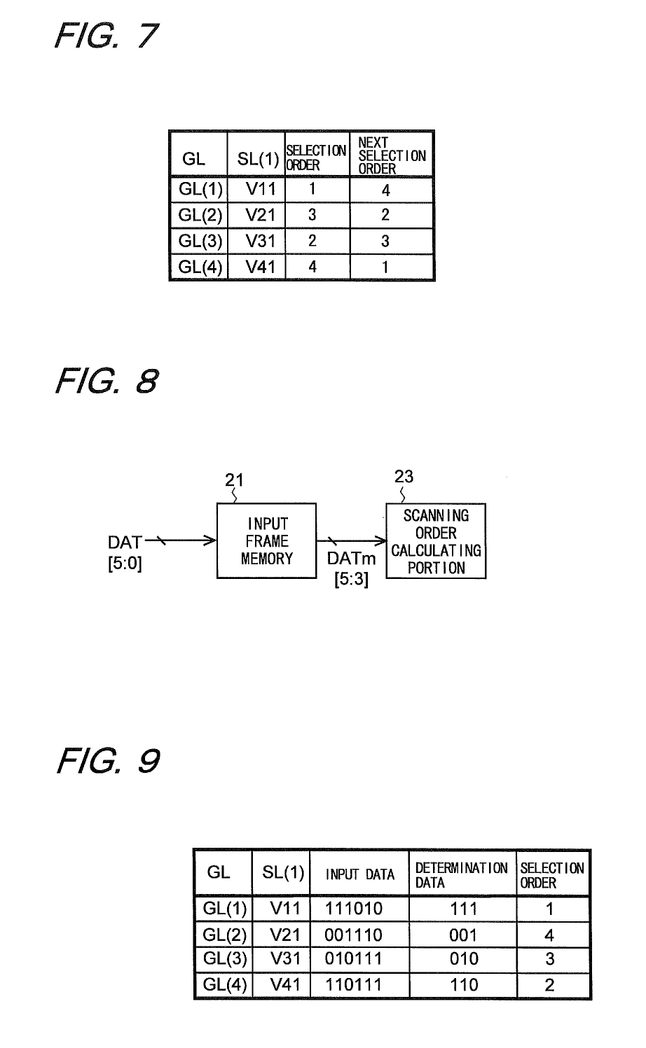

As can be appreciated with reference to FIG. 6, the potential of the video signal line SL(1) changes gradually during the period from time t1 to time t5, and the total amount of potential variation is minimum. If the drive video signal voltages V11 to V41 are applied to their corresponding scanning signal lines in the same order as the lines are arranged, the potential changes significantly from the voltage V11 to the voltage V21 at time t2, and also from the voltage V31 to the voltage V41 at time t4, so that the total amount of potential variation of the video signal line SL becomes considerably larger than that for the case shown in FIG. 6. In this manner, power consumed by driving the video signal line can be reduced by selecting the scanning signal lines in such an order that the total amount of potential variation of the video signal line becomes smaller than that for the case where the scanning signal lines are selected in order of arrangement. Note that the description directed to FIGS. 5 and 6 has been given taking the first configuration as an example, but the same description applies to the aforementioned third configuration. This will be described below with reference to FIG. 7.

FIG. 7 is a table listing the order of selecting the four scanning signal lines and the values of voltages to be applied to the video signal line in the third configuration. The display device upon which FIG. 7 is based is the same as the simplified display device upon which FIG. 5 is based, and the same drive video signal voltages Vj1 (V11 to V41) are used. However, as described above in conjunction with the third configuration, the row that corresponds to the scanning signal line to be selected at the beginning of each frame is the row that is to be selected in order to minimize the total amount of potential variation (integral) of the video signal lines SL(1) to SL(M) relative to the potential applied in the row that corresponds to the scanning signal line selected at the end of the previous frame. Accordingly, the first row for the next frame is the scanning signal line SL(4) corresponding to the fourth row, which is the same as the last row for the preceding frame, as shown in FIG. 7. The row for which the total amount of potential variation is minimum relative to the fourth row is the second row; similarly, the third row is selected next, and the first row is selected last. In this manner, power consumed by driving the video signal lines can be reduced by selecting the scanning signal lines in such an order that the total amount of potential variation of the video signal line becomes smaller than the case where the scanning signal lines are selected in order of arrangement.

### 1.3 Effects

As described above, in the present embodiment, the order of selecting all rows (for one frame) is determined by repeating the following: the row for which the total amount of potential variation relative to the initially set reference row is the lowest is selected as the subsequent row, and the row having been selected as the subsequent row is used as the next reference row in a similar operation to determine the next row to be set as the subsequent row, and the scanning signal lines are selected in the determined order. With this configuration, power consumed by driving the video signal lines can be reduced by selecting the scanning signal lines in such an order that the total amount of potential variation of the video signal line becomes smaller than the case where the scanning signal lines are selected in order of arrangement.

### 1.4 Variants of the First Embodiment

### 1.4.1 First Variant

Next, a first variant of the present embodiment will be described with reference to FIGS. 8 and 9. FIG. 8 is a partial block diagram illustrating a display data signal being inputted to the input frame memory and then to the scanning order calculating portion. As has been described earlier, the input frame memory 21 externally receives a display data signal DAT. The display data signal DAT includes 6-bit grayscale data for each pixel (i.e., each of the R, G, and B pixels), and none of the bits is masked. In the figure, the symbol [5:0], which denotes the contents of the data, is assigned to the display data signal DAT. Moreover, the display data signal DATm provided from the input frame memory 21 to the scanning order calculating portion 23 is the same signal as the display data signal DAT, but the lower three bits of the 6-bit grayscale data are masked. In the figure, the symbol [5:3], which denotes the contents of the data, is assigned to the display data signal DATm. The data for the unmasked upper three bits of the display data signal DATm will be referred to below as determination data.

FIG. 9 is a table listing the order of selecting four scanning signal lines and the values of voltages to be applied to a video signal line, as in FIG. 5, along with corresponding input data and determination data. Here, in a simplified display device, as in the case described in conjunction with FIG. 5, the input data represent grayscale data values that correspond to the drive video signal voltages Vj1 (V11 to V41) applied to the video signal line SL(1), and determination data is the data for the upper three bits (e.g., “111”) from the 6-bit input data (e.g., “111010”), as shown in FIG. 7.

In step S30 shown in FIG. 4 as described earlier, the scanning order calculating portion 23 sequentially calculates the total amount of variation represented by expression (1) for each row, but unlike in the above embodiment, 6-bit input data (grayscale data) corresponding to a video signal to be applied to the video signal line is not used as a whole, and the upper three bits from the six bits are used (i.e., the lower three bits are masked). As has been described earlier, this 3-bit data is referred to herein as determination data. In the example shown in FIG. 7, there is only one video signal line, and therefore, the determination data denotes the total amount of potential variation, but in actuality, the determination data denotes the integral of the amounts of potential variation of a plurality of video signal lines.

By using the upper bits in this manner, the exact amount of potential variation cannot be calculated because the amount to be represented by the lower bits is removed, but the amount of computation can be reduced, and therefore, this configuration is preferable when the computation speed is not sufficient. Further, even if the computation speed is satisfactory, the configuration is preferable in that power consumed by computation can be reduced.

Note that the upper bits are not limited to three bits so long as the amount of potential variation can be calculated, and the number of upper bits can be set within the range of less than the number of bits in the entire input data.

### 1.4.2 Second Variant

Furthermore, to reduce the amount of computation, the integral of the amounts of potential variation of all of the video signal lines SL(1) to SL(M) is not calculated, but some of the amounts may be omitted (without computing them). For example, the total amount of potential variation represented by the following expression (2), rather than by expression (1), may be calculated for each row.

$${\sum }_{i = 1}^{M / 3} {( Va ( 3 i ) - Vj ( 3 i ) )}^{2} \qquad ( 2 )$$

Note that in expression (2), computation is performed for every second video signal line, so that the total amount of variation in the potential to be applied to the video signal lines whose orders are multiples of 3 is calculated, but the video signal lines for which computation is to be performed are not specifically limited. However, to perform computation uniformly across the entire screen, every video signal line whose order is an integer multiple of 2 or more is preferably targeted for computation, as in the case of expression (2).

Furthermore, by applying the configuration of the first variant to the configuration of the second variant, it is rendered possible to further reduce power consumption. Note that the method for determining the order may be applied partially.

### 2. Second Embodiment

### 2.1 Overall Configuration and Operation of the Liquid Crystal Display Device

An active-matrix liquid crystal display device according to the present embodiment has the same configuration as the display device of the first embodiment shown in FIG. 1, except for a part of the display control circuit, and also operates in the same manner, therefore, the same components will be denoted by the same characters, and any descriptions thereof will be omitted.

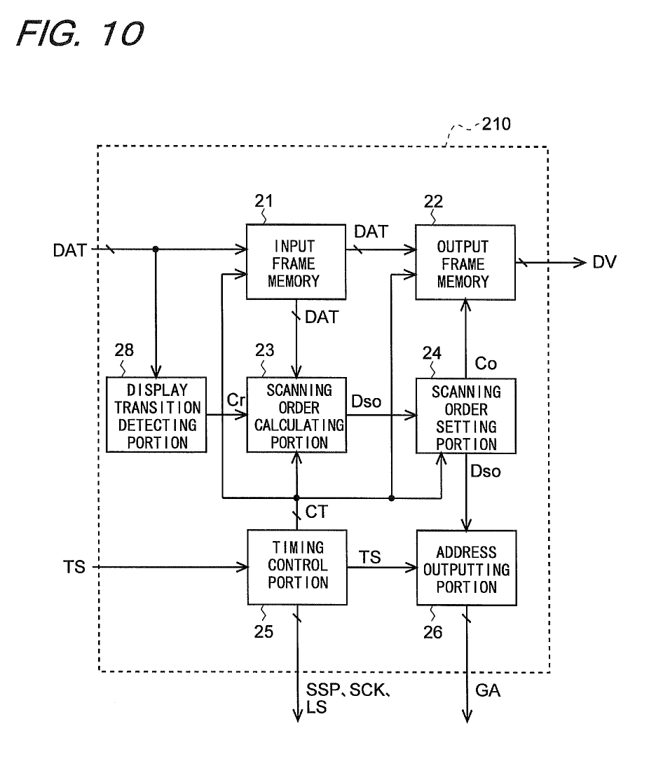

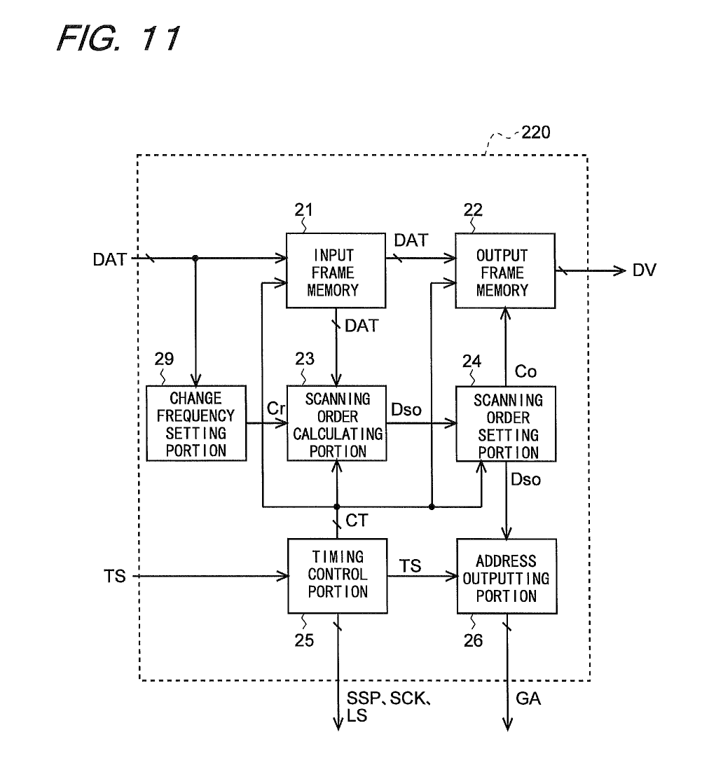

FIG. 10 is a block diagram illustrating the configuration of the display control circuit in the second embodiment of the present invention. As can be appreciated in comparison with the display control circuit 200 shown in FIG. 3, the display control circuit 210 shown in FIG. 10 operates in the same manner and has the same configuration except that a display transition detecting portion 28 is additionally provided, therefore, the same components are denoted by the same characters, and any descriptions thereof will be omitted; the operation of the additionally provided display transition detecting portion 28 will be described.

### 2.2 Operation of the Display Transition Detection Portion

The display transition detecting portion 28 shown in FIG. 10 receives an externally provided display data signal DAT, and detects a change in an image represented by the signal. For example, in the case where the same still image such as a wallpaper is being displayed continuously, the order calculated by the scanning order calculating portion 23 in order to reduce the total amount of potential variation of the video signal lines would not change. Accordingly, the same computation is performed repeatedly, but this is not preferable from the viewpoint of reducing power consumption. Therefore, the display transition detecting portion 28 monitors the details of images (e.g., integrals of pixel grayscale values) frame by frame, and if any change in the details is detected, the display transition detecting portion 28 provides an update control signal Cr to the scanning order calculating portion 23.

Upon reception of the update control signal Cr from the display transition detecting portion 28, the scanning order calculating portion 23 calculates the order of selecting all rows (for one frame), as in the first embodiment. Operations performed thereafter, for example, in order to select the scanning signal lines, are the same as in the first embodiment.

### 2.3 Effects

As described above, in the present embodiment, the scanning order calculating portion 23 calculates the order of selection only upon detection of a change between images by the display transition detecting portion 28. With this configuration, it is possible to reduce the number of times the scanning order calculating portion 23 performs computation, resulting in less power consumed by computation.

### 2.4 Variants of the Second Embodiment

FIG. 11 is a block diagram illustrating the configuration of a display control circuit in a variant of the second embodiment of the present invention. As can be appreciated in comparison with the display control circuit 210 shown in FIG. 10, the display control circuit 220 shown in FIG. 11 operates in the same manner and has the same configuration except that a change frequency setting portion 29 is provided in place of the display transition detecting portion 28, therefore, the same components are denoted by the same characters, and any descriptions thereof will be omitted; the operation of the change frequency setting portion 29 will be described.

The change frequency setting portion 29 shown in FIG. 11 receives an externally provided display data signal DAT, and detects whether the image represented by the signal is a still image or a video image; in the case of a still image, an update control signal Cr is outputted in longer cycles (or with a lower frequency) than in the case of a video image. For example, in the case where a still image is being displayed, the order calculated by the change frequency setting portion 29 in order to reduce the total amount of potential variation of the video signal lines would change less frequently than in the case where a video image is being displayed. Accordingly, the same or similar computation is performed repeatedly in short cycles (or with a high frequency), but this is not preferable from the viewpoint of reducing power consumption. Therefore, the change frequency setting portion 29 monitors the details of images (e.g., integrals of pixel grayscale values) frame by frame, and if a determination is made that a still image is being displayed, the update control signal Cr is provided to the scanning order calculating portion 23 in long cycles (e.g., once per second), or if a determination is made that a video image is being displayed, the update control signal Cr is provided to the scanning order calculating portion 23 in short cycles (e.g., every frame).

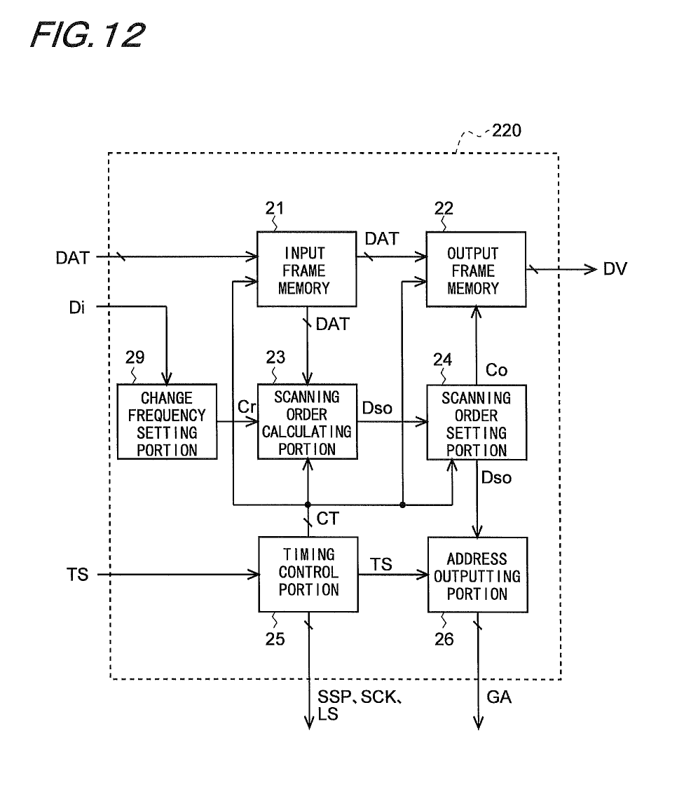

Furthermore, in a conceivable configuration shown in FIG. 12, the change frequency setting portion 29 operates differently compared to the manner as illustrated in FIG. 11. FIG. 12 is a block diagram illustrating the configuration of a display control circuit in another variant of the second embodiment of the present invention. The change frequency setting portion 29 shown in FIG. 12 operates differently from that shown in FIG. 11 in that it receives image detail information Di, which indicates the image represented by the display data signal DAT is a video image or a still image, from the outside (e.g., a host controller), and makes a determination as in the above variant, on the basis of the received image detail information Di before providing the update control signal Cr to the scanning order calculating portion 23 in corresponding cycles (or with a corresponding frequency).

Note that upon reception of the update control signal Cr from the change frequency setting portion 29, the scanning order calculating portion 23 shown in FIG. 11 or 12 calculates the order of selecting all rows (for one frame), as in the first embodiment. Operations performed thereafter, for example, in order to select the scanning signal lines, are the same as in the first or second embodiment.

As described above, in this variant of the present embodiment, the change frequency setting portion 29 detects whether an image is a still image or a video image, and in the case of a still image, the scanning order calculating portion 23 calculates the order of selection in longer cycles (or with a lower frequency) than in the case of a video image. With this configuration, it is possible to reduce the number of times the scanning order calculating portion 23 performs computation, resulting in less power consumption by computation. Moreover, in the configuration of this variant, unlike in the configuration of the second embodiment where the image is not updated unless it changes significantly, the details of computation are updated, even though such updates occur with a low frequency, so that the total amount of potential variation of the video signal lines can be further reduced even when changes between images are gradual, resulting in a further reduction in power consumption.

### 3. Third Embodiment

### 3.1 Overall Configuration and Operation of the Liquid Crystal Display Device

An active-matrix liquid crystal display device according to the present embodiment has the same configuration as the display device of the first embodiment shown in FIG. 1, except for a part of the display control circuit, and also operates in the same manner, therefore, the same components will be denoted by the same characters, and any descriptions thereof will be omitted.

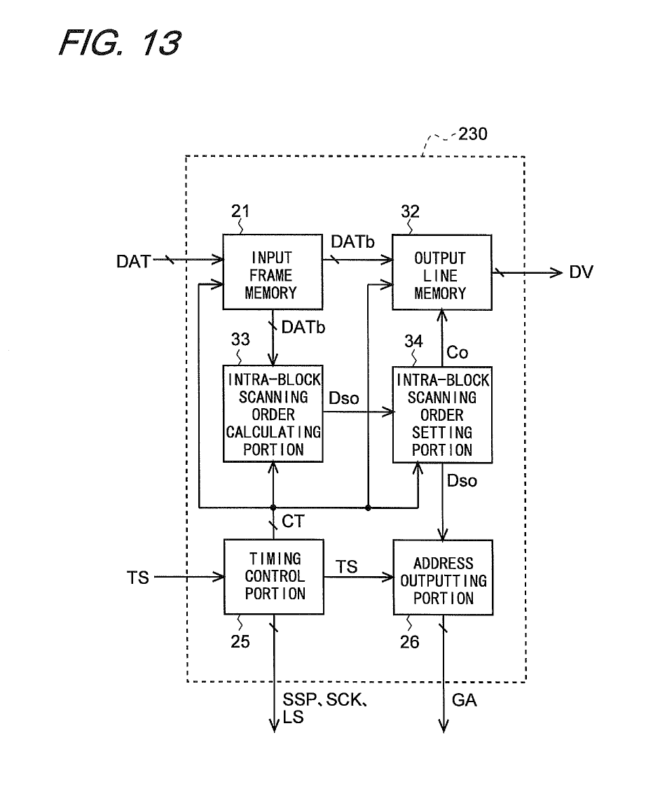

FIG. 13 is a block diagram illustrating the configuration of the display control circuit in the third embodiment of the present invention. As can be appreciated in comparison with the display control circuit 200 shown in FIG. 3, the display control circuit 230 shown in FIG. 13 operates in the same manner and also has the same configuration except that output line memory 32 is provided in place of the output frame memory 22, an intra-block scanning order calculating portion 33 is provided in place of the scanning order calculating portion 23, and an intra-block scanning order setting portion 34 is provided in place of the scanning order setting portion 24, therefore, the same components are denoted by the same characters, and any descriptions thereof will be omitted.

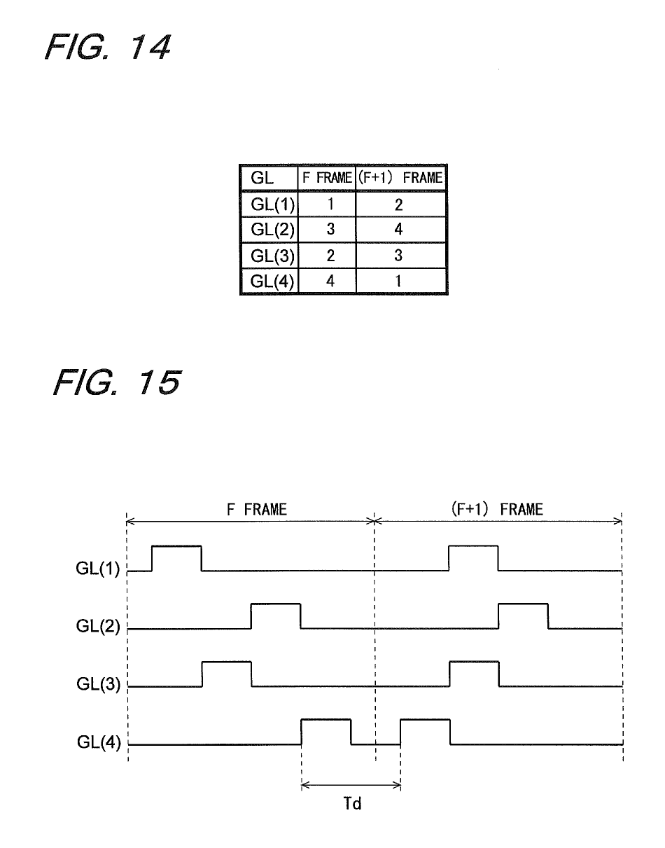

The display control circuit 230 in the present embodiment renders it possible to avoid problems that can be caused in the case of the first embodiment. Such problems will be described below with reference to FIGS. 14 and 15.

FIG. 14 is a table listing the order of selecting scanning signal lines for two consecutive frames in a simplified display device as in the first embodiment, and FIG. 15 provides waveform charts showing potential changes of the scanning signal lines selected in the order of selection shown in FIG. 14. The scanning signal line GL(4) is the last scanning signal line selected in the F′ th frame is an arbitrary integer; referred to below as the “F frame”) and also the first scanning signal line selected in the (F+1)'th frame (referred to below as the “(F+1) frame”), as shown in FIG. 14.

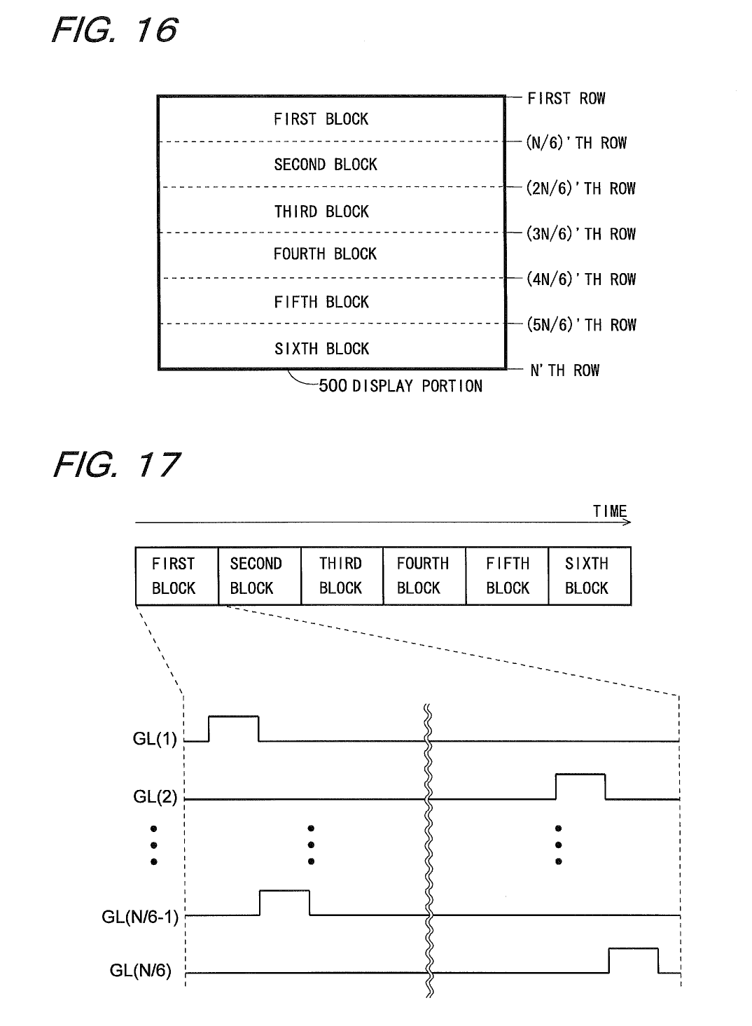

Accordingly, the duration in which the pixels selected through the scanning signal line GL(4) in the F frame are displayed lasts only for a period Td until the scanning signal line GL(4) is selected in the following (F+1) frame, as shown in FIG. 15. The period Td is approximately equal to the length of a vertical blanking period, and therefore is considerably shorter than one frame period, which is an average pixel display period. In this manner, when there is a significant discrepancy between durations in which to hold pixel tones, the screen might be garbled, resulting in a severe problem with display quality. In the configuration of the present embodiment, this problem can be avoided by selecting the scanning signal lines block by block in predetermined order. This block-by-block selection approach will be described below with reference to FIGS. 16 and 17.

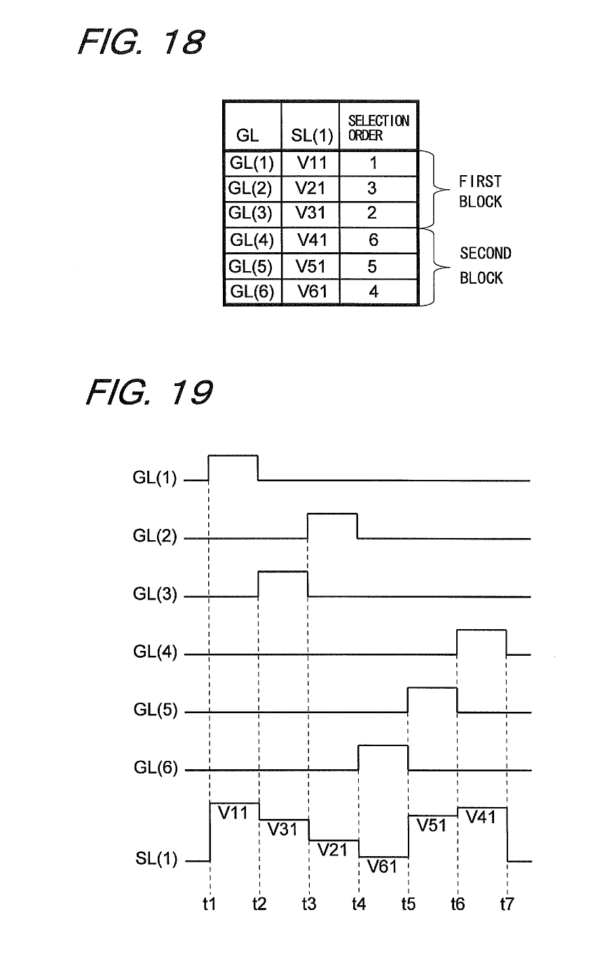

FIG. 16 is a diagram illustrating an example where a display screen is divided into six blocks, and FIG. 17 is a diagram partially illustrating potential changes of the scanning signal lines in the six blocks. The display screen presented by the display portion 500 is divided into six blocks, i.e., first through sixth blocks, as shown in FIG. 16, such that, for example, the first block is a group consisting of the scanning signal lines that correspond to the first through (N/6)'th rows. Moreover, the scanning signal lines GL(1) to GL(N/6) grouped as the first block are selected in selection order determined by a similar approach to that of the first embodiment, as shown in FIG. 17, and once the scanning signal lines in the first block are completely selected, the scanning signal lines that belong in the following second block are selected in similarly determined selection order, as shown in FIG. 17; a similar process is repeated until selection within the sixth block is complete. In this manner of selecting the scanning signal lines, for example, the last scanning signal line selected in the first block in the F frame is selected first in the first block in the following (F+1)'th frame, but there is a selection interval of at least approximately one frame period (precisely, about ⅚ of a frame period), and therefore, the problem where the display period is considerably short as mentioned above does not occur. Thus, display quality can be prevented from being reduced. The operation of the intra-block scanning order calculating portion 33 and the operation of the intra-block scanning order setting portion 34 will be described next in a specific example with reference to FIGS. 18 and 19.

FIG. 18 is a table listing the order of selecting six scanning signal lines and the values of voltages to be applied to a video signal line. For a simple example of a display device including the six scanning signal lines GL(1) to GL(6) and the video signal line SL(1), FIG. 18 lists the order of selection and the drive video signal voltages Vj1 (V11 to V41) to be applied to the video signal line SL(1) where the scanning signal lines GLj (where j=1 to 4) are selected.

As can be appreciated by comparing FIG. 18 with FIG. 5, in the configuration shown in FIG. 18, the order of selection is determined block-by-block. The blocks are determined by setting groups of a plurality of (here, three) adjacent scanning signal lines. More specifically, a first block consists of three scanning signal lines GL(1) to GL(3), and a second block consists of three scanning signal lines GL(4) to GL(6). The order of selection is tentatively assigned within each of the first and second blocks independently of each other, and the block closest to the first row is selected ahead of the other. Accordingly, the tentative order of selection within the first block is as follows: scanning signal line GL(1); scanning signal line GL(3); and scanning signal line GL(2), and the tentative order of selection within the second block is as follows: scanning signal line GL(6); scanning signal line GL(5); and scanning signal line GL(4). Accordingly, the final order of selection is the order as shown in FIG. 18. Although the example of the simplified device has been given here, in actuality, several to hundreds of such blocks are provided. The operation will be described further specifically with reference to FIG. 19.

FIG. 19 provides waveform charts of signals in the simple example of the display device as above. The scanning signal lines GL(1) to GL(6) are selected in selection order shown in FIG. 18, so that the scanning signal line GL(1) is active from time t1 to time t2, the scanning signal line GL(3) is active from time t2 to time t3, the scanning signal line GL(2) is active from time t3 to time t4, the scanning signal line GL(6) is active from time t4 to time t5, the scanning signal line GL(5) is active from time t5 to time t6, the scanning signal line GL(4) is active from time t6 to time t7, as shown in FIG. 19. Moreover, when the scanning signal lines are respectively activated, their corresponding drive video signal voltages V11 to V61 are applied to the video signal line SL(1).

As can be appreciated with reference to FIG. 19, the potential of the video signal line SL(1) changes gradually during the period from time t1 to time t7, so that the total amount of potential change is minimum. If the corresponding drive video signal voltages V11 to V61 are applied in the same order as the scanning signal lines are arranged, the potential changes significantly from the voltage V11 to the voltage V21 at time t2, and also from the voltage V31 to the voltage V41 at time t4, so that the total amount of potential change of the video signal line SL becomes considerably larger than that for the case shown in FIG. 19. In this manner, power consumed by driving the video signal lines can be reduced by selecting the scanning signal lines in such an order that the total amount of potential variation of the video signal line becomes smaller than the case where the scanning signal lines are selected in order of arrangement.

In the present embodiment, the scanning signal lines are grouped into a plurality of blocks such that the scanning signal lines included in each block are selected appropriately so as to reduce power consumption within that block, but from the viewpoint of reducing power consumption, the selection not by the grouping in the first embodiment is more preferable.

However, since the blocks are sequentially selected in order from the closest to the first row, the period of time from selection of one of the scanning signal lines within a block until selection of one of the scanning signal lines within the same block in the next frame is approximately constant, so that there is an interval of approximately one frame between the selections (if the size of the block is sufficiently small). Accordingly, the duration in which to hold pixel tones in each row is approximately equal to one frame period, and therefore, there arises no severe problem with display quality. Note that in the case where the block size is large, even if the number of blocks is, for example, two, the hold duration is ensured to be a minimum of half a frame, and therefore, still, there arises no severe problem with display quality.

In this respect, in the case of the first embodiment, if the row selected first in the first frame is selected last in the next frame, the duration in which to hold the pixel tones in the same row is approximately equal to a time period for two frames, but if the row selected last in the first frame is selected first in the next frame, the duration in which to hold the pixel tones in the same row is approximately equal to a time period only for a vertical blanking period. In this manner, if there is a significant discrepancy between the durations in which to hold the pixel tones, the screen might be garbled, resulting in a severe problem with display quality. The configuration of the present embodiment renders it possible to avoid this problem.

Furthermore, in the present embodiment, the order of selection is calculated on a block-by-block basis, as in the first embodiment, but once calculation for one block is completed, calculation for the next block starts, so that it is not necessary to hold data for one frame to be outputted, and data for only one block (or two blocks including data in an output buffer) is held. Accordingly, line memory capable of holding such data can be used. Such line memory is small in circuit scale and also inexpensive, and therefore, by using the output line memory 32, it is rendered possible to reduce production cost of the device and also the circuit scale of the display control circuit 230.

### 3.2 Effects

As described above, in the present embodiment, the scanning signal lines are grouped into a plurality of blocks, the order of selection within each group is calculated so as to minimize the amount of potential variation of the video signal line, thereby reducing power consumption as in the first embodiment, and the order of selection among the groups is fixed, so that the hold duration can be ensured to be at least half a frame, whereby satisfactory display quality can be maintained.

### 4. Variants of the Embodiments

Note that all or a part of the functions of the display control circuit in each of the embodiments may be included in a host controller or a discrete drive control circuit independent of that. Moreover, such functions can be realized by a microcomputer executing corresponding programs.

The above embodiments have been described taking the active-matrix liquid crystal display device as an example, but this is not limiting, and the present invention can also be applied to display devices using LEDs (light-emitting diodes), such as organic EL (electroluminescence) elements, as well as other flat-panel display devices, so long as they are active-matrix display devices.

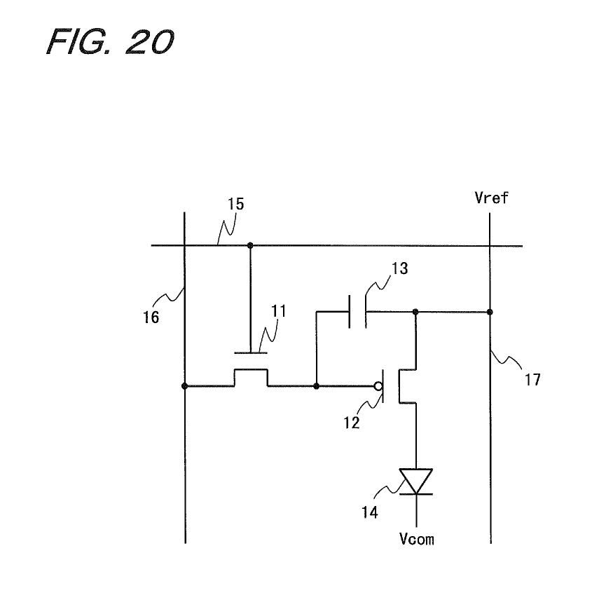

FIG. 20 is a circuit diagram illustrating an equivalent circuit of a pixel forming portion using an organic EL element. The pixel forming portion includes the organic EL element 14, which is an electro-optic element, a power line electrode 17 for supplying a current from a drive power source Vref (an unillustrated current supply portion), a scanning signal line electrode 15 connected to a scanning signal line drive circuit (gate driver circuit), a video signal line electrode 16 connected to a video signal line drive circuit (source driver circuit), a common electrode Vcom, an auxiliary capacitance 13, a current control TFT 12, which is a p-channel TFT for controlling the current to be applied to the organic EL element 14, and a data voltage control TFT 11, which is an n-channel TFT for controlling the timing of applying the current to the organic EL element 14, as shown in FIG. 20. The pixel forming portion is driven in a so-called constant voltage control mode (a voltage programming mode). More specifically, a video signal voltage is applied to the video signal line electrode 16 while the data voltage control TFT 11 is being selected by a scanning signal provided to the scanning signal line electrode 15, so that a voltage corresponding to the video signal voltage is held in the auxiliary capacitance 13. Thereafter, during a period in which the data voltage control TFT 11 is not selected, the conductivity of the current control TFT 12 is controlled in accordance with the voltage held in the auxiliary capacitance 13. In this manner, a predetermined current is applied to the organic EL element 14 connected in a series to the current control TFT 12, thereby controlling the amount of light emission of the organic EL element. The configuration of each of the embodiments can also be applied to an organic EL display device including such pixel circuits.

### INDUSTRIAL APPLICABILITY

The present invention is applied to display devices such as active-matrix liquid crystal display devices, and is particularly suitable for display devices for which low power consumption is required.

### DESCRIPTION OF THE REFERENCE CHARACTERS

10 TFT (switching element)
21 input frame memory
22 output frame memory
23 scanning order calculating portion
24 scanning order setting portion
25 timing control portion
26 address outputting portion
32 output line memory
33 intra-block scanning order calculating portion
34 intra-block scanning order setting portion
200 to 230 display control circuit
300 video signal line drive circuit
1400 scanning signal line drive circuit
500 display portion
DAT display data signal (image signal)
DV digital image signal
Epix pixel electrode
GL(n) scanning signal line (n=1 to N)
SL(m) data line (m=1 to M)
P(m, n) pixel forming portion (n=1 to N, and m=1 to M)

1. A display device for displaying an image by a plurality of pixel forming portions arranged along a plurality of video signal lines for transmitting a plurality of video signals and a plurality of scanning signal lines crossing the video signal lines, the device comprising:
a video signal line drive circuit for driving the video signal lines on the basis of an image signal representing the image;
a scanning signal line drive circuit for selectively driving the scanning signal lines; and
a scanning order determination circuit for determining order of selecting the scanning signal lines on the basis of the image signal so that the video signal lines are driven with lower power than power required for driving the video signal lines when the scanning signal lines are selected in order of arrangement.

2. The display device according to claim 1, wherein the scanning order determination circuit determines at least a part of the order so as to minimize an integral of absolute values of amounts of potential variation caused for each of at least a part of the video signal lines upon each change of a scanning signal line selected by the scanning signal line drive circuit.

3. The display device according to claim 2, wherein the scanning order determination circuit determines a scanning signal line to be selected next so as to minimize the integral of the absolute values of the amounts of potential variation, and the scanning order determination circuit also determines another scanning signal line to be selected following the selection of the preceding scanning signal line so as to minimize the integral of the absolute values of the amounts of potential variation.

4. The display device according to claim 3, wherein the scanning order determination circuit determines a scanning signal line that is to be selected first from among the scanning signal lines to display the image, so as to minimize the integral of the absolute values of the amounts of potential variation, the first scanning signal line being selected next after the last scanning signal line selected so as to display an immediately preceding image.

5. The display device according to claim 3, wherein the scanning order determination circuit determines a scanning signal line that is to be selected first from among the scanning signal lines, so as to minimize an integral of absolute values of potential differences of the video signal lines from a predetermined potential.

6. The display device according to claim 3, wherein the scanning order determination circuit determines a scanning signal line that is to be selected to display the first row of the image, as the first to be selected from among the scanning signal lines.

7. The display device according to claim 2, wherein the scanning order determination circuit calculates the integral on the basis of a predetermined number of upper bits of digital grayscale data included in the image signal and representing potentials to be applied to the video signal lines.

8. The display device according to claim 1, wherein after determining the order, the scanning order determination circuit maintains the order until a predetermined wait period passes or until a predetermined start point.

9. The display device according to claim 8, wherein the scanning order determination circuit sets the start point to be a point of detection of a change in the image or sets the wait period longer when the image is determined to be a still image than when the image is determined to be a video image.

10. The display device according to claim 1, wherein the scanning order determination circuit divides the video signal lines into groups of a predetermined number of adjacent scanning signal lines, and determines the order for each group.

11. The display device according to claim 10, further comprising memory with a capacity for storing digital grayscale data specifying potentials to be provided to the video signal lines in one of the groups.

12. The display device according to claim 2, wherein the scanning order determination circuit adds up absolute values of amounts of potential variation for each video signal line selected every predetermined integer multiple of 2 or more from among the video signal lines.

13. The display device according to claim 1, wherein,
the scanning signal line drive circuit is an address decoder, and
the scanning order determination circuit provides the scanning signal line drive circuit with addresses in accordance with the order.

14. The display device according to claim 1, wherein the scanning signal line drive circuit is disposed on each end side of the scanning signal lines such that the scanning signal lines are provided with signals at least from one end.

15. A method for displaying an image by a plurality of pixel forming portions arranged along a plurality of video signal lines for transmitting a plurality of video signals and a plurality of scanning signal lines crossing the video signal lines, the method comprising:
a video signal line drive step for driving the video signal lines on the basis of an image signal representing the image;
a scanning signal line drive step for selectively driving the scanning signal lines; and
a scanning order determination step for determining the order of selecting the scanning signal lines on the basis of the image signal so that the video signal lines are driven with lower power than power required for driving the video signal lines when the scanning signal lines are selected in order of arrangement.
